(19) United States
(12) Patent Application Publication
(10) Pub. No.: US 2008/0019402 A1
(43) Pub. Date: Jan. 24, 2008

(54) APPARATUS AND METHOD FOR PID CONVERSION IN VERY HIGH FREQUENCY DIGITAL RADIO BROADCASTING RECEIVER

(75) Inventors: Jin-Kyu PARK, Yongin-si (KR); Suk-Jin Jung, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/779,540

(22) Filed: Jul. 18, 2007

(30) Foreign Application Priority Data
Jul. 19, 2006 (KR) 67493/2006

(51) Int. Cl. H04J 3/04; H04L 27/00; H04N 11/04

(52) U.S. Cl. 370/535; 375/240.01; 375/316

(57) ABSTRACT

An apparatus and a method for Packet Identifier (PID) conversion in a Very High Frequency (VHF) digital radio broadcasting receiver. In the method, a reception side can identify a PID corresponding to each service when at least two video services are provided using an identical PID within one ensemble of the VHF digital radio broadcasting receiver.

### PRIORITY

This application claims priority under 35 U.S.C. §119(a) to an application filed in the Korean Industrial Property Office on Jul. 19, 2006 and assigned Serial No. 2006-67493, the contents of which are hereby incorporated by reference.

### BACKGROUND OF THE INVENTION

1. Field of the Invention

The present invention generally relates to a Very High Frequency (VHF) digital radio broadcasting receiver, and more particularly to an apparatus and a method for Packet Identifier (PID) conversion in a VHF digital radio broadcasting receiver.

2. Description of the Related Art

A VHF digital radio broadcasting system has a structure for transmitting contents of the Moving Picture Experts Group-4 (MPEG-4) standard in a stream mode using MPEG-2 Transport Stream (TS).

FIG. 1 shows a conventional structure for transmitting a video service. The video service refers to a service including video basically provided from digital radio broadcasting, and voice, sound, or subsidiary data for the video. The subsidiary data refers to service components encoded by a subsidiary data compression process used for a video service. For example, the service components include scene description data and graphic data.

Information regarding video, audio, and subsidiary data for the video service is multiplexed according to the MPEG-2 by a video multiplexer 110. The multiplexed streams are transmitted using a digital radio broadcasting transmission mechanism. In the transmission mechanism, the multiplexed streams are multiplexed with audio and data services and the multiplexed data is transmitted through a Main Service Channel (MSC). Video data streams are transmitted by using a stream mode defined by the digital radio broadcasting transmission mechanism.

The video service generates service streams through the following steps.

(1) An input image signal is encoded, so Elementary Streams (ESs) are generated from video data encoded by, for example, H.264/Advanced Video Coding (AVC), audio data encoded by, for example, a Bit Sliced Arithmetic Coding (BSAC) standard, and subsidiary data, such as BInary Format for Scene (BIFS), respectively.

(2) Synchronization is acquired between the generated ESs, and each of the generated ESs is packetized again into Synchronization Layer (SL) packets, so concatenation between the ESs can be made possible.

(3) Each of the generated SL packets is converted into a Packetized Elementary Stream (PES) packet to which the stream information, such as a stream identifier (ID), a length, etc. is added.

(4) Each of the PES packets is converted into a TS packet having a fixed length of, for example, 188 bytes in preparation for transmission of the packets through channels having a transmission error. In this step, each video PES packet and each audio PES packet include a specific PID.

Steps by a reception side having received the video service packet produced as described above, which are inverse to the above-mentioned steps of generating a video service stream, will now be described.

(1) A TS demultiplexer divides each of the received MPEG-2 TS packets into a video packet and an audio packet based on the PID.

(2) A PES packet is extracted from the divided video packet and the divided audio packet.

(3) An SL packet is extracted from the PES packet.

(4) An ES packet is extracted from the SL packet.

(5) The video ES packet is performed according to the H.264 decoding and the audio ES packet is performed according to the BSAC decoding, and the synchronization information obtained in the previous step (4) is used to synchronize the audio data with the video data.

As can be seen from the steps for video service processing of the reception side, each of packets has a specific PID whose value is important information capable of respectively identifying video and audio packets of a corresponding video service.

FIG. 2 shows a conventional video multiplexer that includes an Initial Object Descriptor (IOD) generator 211, an Object Descriptor (OD)/BIFS generator 213, a video encoder 215, an audio encoder 217, an SL packetizer 218, a section generator (PSI generator) 220, a PES packetizer 222, a TS multiplexer 230, an external encoder 252, and a convolutional interleaver 254 (i.e. external interleaver).

The IOD generator 211 generates an IOD based on, for example, the International Organization for Standardization/International Electrotechnical Commission 14496-1 (ISO/IEC 14496-1) standard. The OD/BIFS generator 213 generates an OD/BIFS stream based on, for example, the ISO/IEC 16696-1 standard. The video encoder 215 encodes the input image signals, based on the H.264/AVC standard. The audio encoder 217 encodes the input audio signals, based on the ISO/IEC 14496-3 BASC standard. The SL packetizer 218 generates an SL packet, which is a synchronization packet, from each of media streams, based on the ISO/IEC 14496-1 system standard. The section generator (PSI generator) 220 generates a section including the input IOD/OD/BIFS, based on the ISO/IEC 13818-1 standard. The PES packetizer 222 converts the input SL packet into a PES packet, based on the ISO/IEC 13818-1 standard. The TS multiplexer 230 multiplexes the input session and the input PES packet into an MPEG-2 TS. The external encoder 252 adds additional data of a Reed-Solomon code to the multiplexed MPEG-2 TS to perform error correction. The convolutional interleaver 254 mixes data streams output through an external encoding of the external encoder 252, thereby outputting the mixed data stream in the form of a video service stream.

FIG. 3 shows a conventional format of an MPEG-2 TS packet. The MPEG-2 TS packet of FIG. 3 includes 4 bytes of header 310 and 184 bytes of payload 320. The header 310 includes an 8-bit sync byte field 311, a 1-bit transport_error_indicator field 313, a 1-bit payload unit_start_indicator field 315, a 1-bit transport_priority field 317, a 13-bit PID field 319, a 2-bit transport_scrambling control field 321, a 2-bit adaption_field_control field 323, and a 4-bit continuity_counter field 325.

It is noted from FIG. 3 that the header 310 includes 13 bits of a PID 319. A method, in which service identification is performed when at least two services are provided using identical PIDs within one ensemble, will now be described.

FIG. 4 shows a conventional structure of video service multiplexing. In FIG. 4, there may be various services or service components within one ensemble 410.

The ensemble label 410, which is illustrated as corresponding to a “video service ensemble #1” 412, transmits multiple services including an alpha 1 radio 422, a beta radio 424, an alpha 2 radio 426, etc.

In a case of a first service named “alpha 1 radio 422,” which is an audio service, the service label 420 transmits audio 442 to a main service component, and transmits a Traffic Message Channel (TMC) 444 and Service Information (SI) 446 to two sub-service components, respectively.

In a case of a second service named “beta radio 424” which is a video service, the service label 420 transmits video service (video-1) 448 to a main service component, and transmits secondary audio 450 to a sub-service component.

In a case of a third service named “alpha 2 radio 426”, the service label 420 has an example of a construction capable of changing a video service to an audio service, according to occasion demands.

Therefore, there are various services or service components within one ensemble 410, so it is possible to provide at least two video services. It is possible to provide each video service based on an identical PID of video and audio according to a broadcasting provider.

However, when identical PIDs within one ensemble are used for services, it is impossible for the reception side to identify to which service a video packet or audio packet, which is separated in a step (the first step by the receiver side) of separating each of the received MPEG-2 TS packets into a video packet and an audio packet, belongs. Then, it is impossible to implement a normal video service.

Also, there is another method for adding separate bits to a TS packet header so that the TS reception side can identify a TS. However, when separate bits are added to a TS packet header, the imposed transmission overhead increases.

### SUMMARY OF THE INVENTION

Accordingly, the present invention solves the above-mentioned problems occurring in the prior art, and provides an apparatus and a method for PID conversion in a VHF digital radio broadcasting receiver, by which a reception side can identify a PID corresponding to each service when at least two video services are provided using an identical PID within one ensemble of the VHF digital radio broadcasting receiver.

The present invention also provides an apparatus and a method for PID conversion in a VHF digital radio broadcasting receiver so only a PID is converted to identify a TS without imposed transmission overhead.

The present invention also provides an apparatus and a method for PID conversion in a VHF digital radio broadcasting receiver, by which a PID corresponding to each service is identified to implement a normal video service when at least two video services are provided using an identical PID within one ensemble of the VHF digital radio broadcasting receiver.

In accordance with an aspect of the present invention, there is provided an apparatus for PID conversion in a digital radio broadcasting receiver, the apparatus including a receiver for receiving PIDs within TS packets; a mask bit generator for generating a mask bit when there are duplicated PIDs in the received PIDs; and an operation unit for operating the generated mask bit and at least one of the duplicated PIDs, and outputting a converted PID.

In accordance with another aspect of the present invention, there is provided a method for PID conversion in a digital radio broadcasting receiver, the method including receiving PIDs within TS packets; generating a mask bit when there are duplicated PIDs in the received PIDs; and operating the generated mask bit and at least one of the duplicated PIDs, and outputting a converted PID.

In accordance with further aspect of the present invention, there is provided a digital radio broadcasting receiver including a demultiplexer for demultiplexing TS packets received through a wireless network and outputting the demultiplexed packets; a decoder for decoding the demultiplexed TS packets; and a PID converter for generating a mask bit when there are duplicated PIDs in PIDs of the decoded TS packets, operating the generated mask bit and one of the duplicated PIDs, and outputting a converted PID.

### BRIEF DESCRIPTION OF THE DRAWINGS

The above and other aspects, features and advantages of the present invention will be more apparent from the following detailed description taken in conjunction with the accompanying drawings, in which:

FIG. 1 is a conventional structure for transmitting a video service;

FIG. 2 is a video multiplexer;

FIG. 3 is a format of an MPEG-2 TS packet;

FIG. 4 is a conventional structure of video service multiplexing;

FIG. 5 is a block diagram illustrating a Reed-Solomon (RS) decoder within a video multiplexer according to the present invention;

FIGS. 6 and 7 are flow diagrams illustrating that a TS reception side identifies a PAT of each sub-channel and the TS reception side performs TS data demultiplexing;

FIG. 8 is a flow diagram illustrating a method for PID conversion, in which it is determined based on PAT information of each sub-channel obtained by FIGS. 6 and 7 when PIDs of respective ESs are duplicately used, and the PID conversion is performed when a PID is duplicately used; and

FIG. 9 is a block diagram illustrating a PID converter according to the present invention.

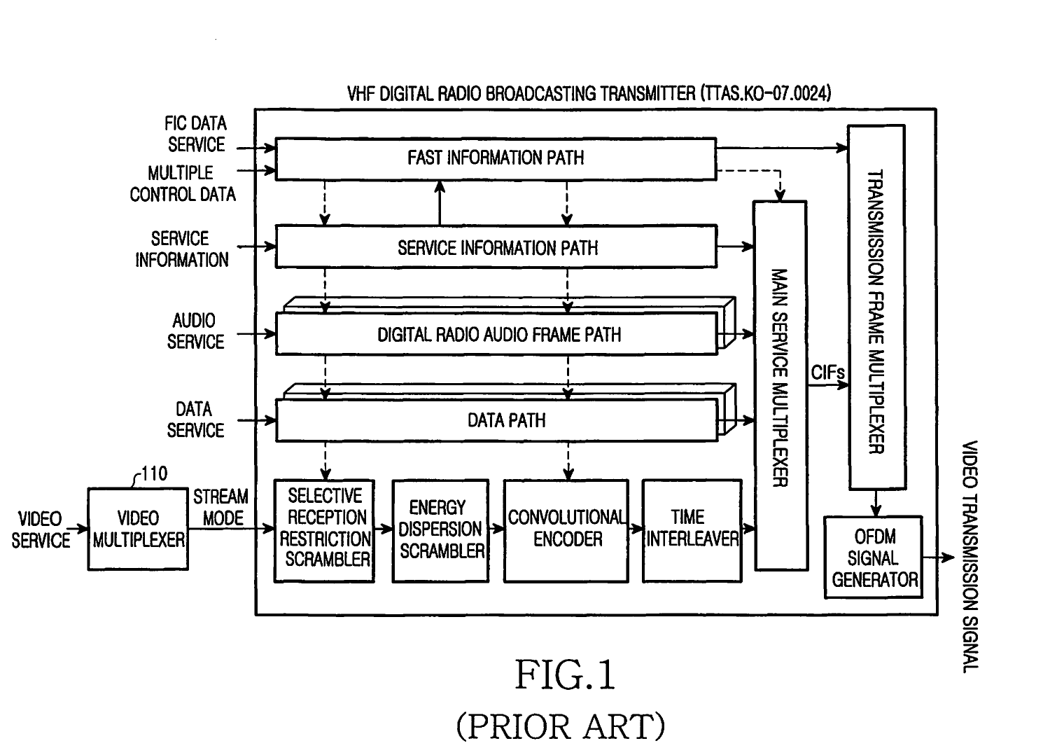

### DETAILED DESCRIPTION OF THE EXEMPLARY EMBODIMENTS

Preferred embodiments of the present invention will be described with reference to the accompanying drawings. In the following description, a detailed description of known functions and configurations incorporated herein will be omitted when it may make the subject matter of the present invention rather unclear. The terms used herein are defined in consideration of functions of the present invention, which may be changed according to the intention of a user or an operator, custom, etc. Therefore, the definition should be based on the overall description of the present invention.

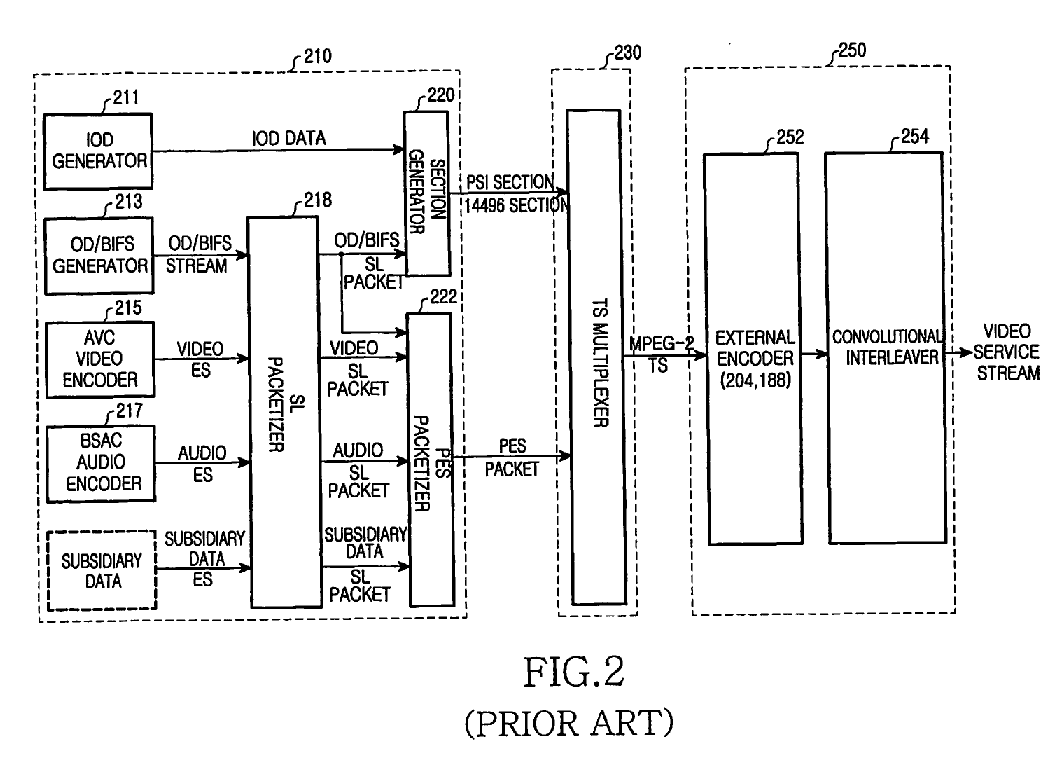

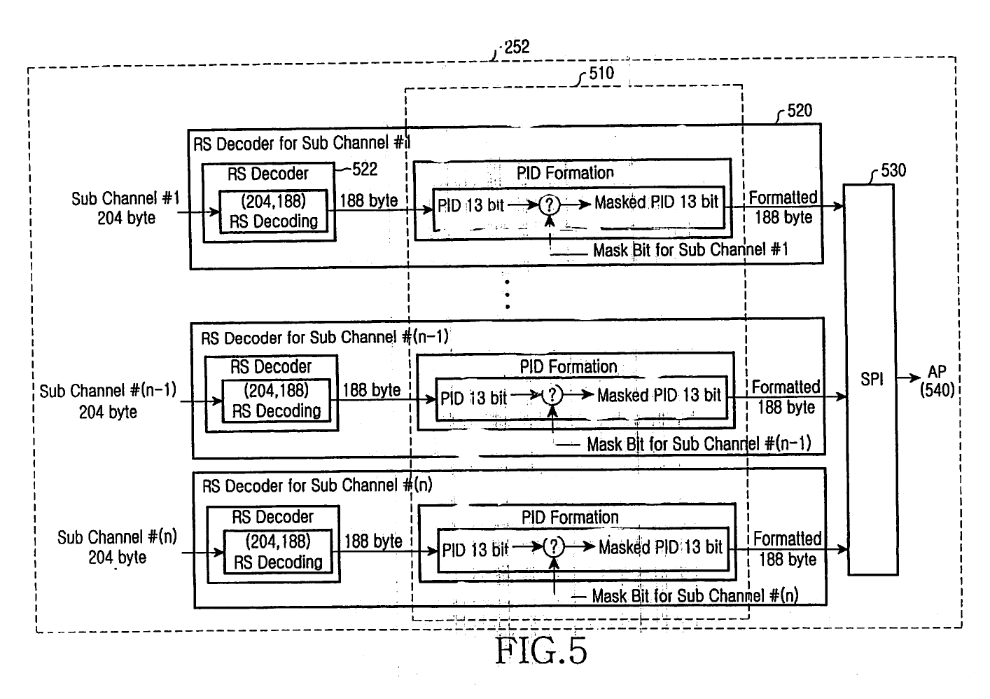

FIG. 5 shows a Reed-Solomon (RS) decoder within a video multiplexer according to the present invention. In the present invention, an external encoder 252 shown in FIG. 2 is provided with a Packet Identifier (PID) converter 510, to identify a PID corresponding to each service.

A terminal receives a stream mode data to provide a video service of Very High Frequency (VHF) digital radio broadcasting, and performs OFDM demodulation. Then, the terminal transmits the demodulated data to a bit deinterleaver (not shown). In the above-described Orthogonal Frequency Division Multiplexing (OFDM) demodulation, all broadcasting data is processed based on each Fast Fourier Transform (FFT) symbol. The bit deinterleaver deinterleaves the received broadcasting signals based on each bit, and then transmits the resultant signal to a Viterbi decoder (not shown). From the bit deinterleaving step process, the data is processed based on each sub-channel on which each service of broadcasting station is provided. The Viterbi decoder decodes the received broadcasting signals and then transmits the decoded signals to a byte deinterleaver (not shown).

The byte deinterleaver deinterleaves the received broadcasting signals based on each byte and then transmits the deinterleaved signals to an RS decoder 520. The RS decoder 520 restores error signals of the deinterleaved reception signals by using parity data, and then outputs the MPEG-2 Transport Stream (TS) packets. The RS decoder 520 within the video multiplexer then decodes each of the video services based on each corresponding sub-channel, as shown in FIG. 5. A TS demultiplexer of the reception side (not shown) divides the MPEG-2 TS packet (i.e. the result of the RS decoding) into a video packet and an audio packet by using a PID.

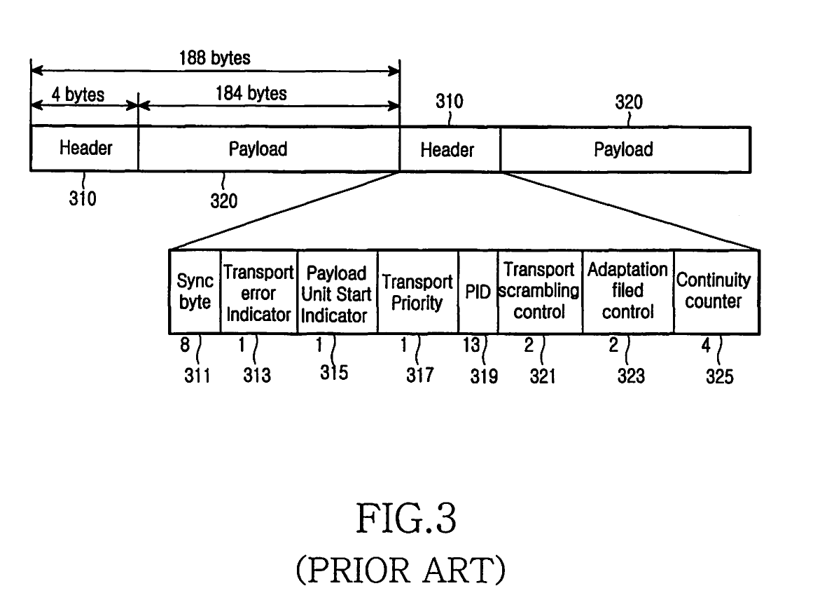

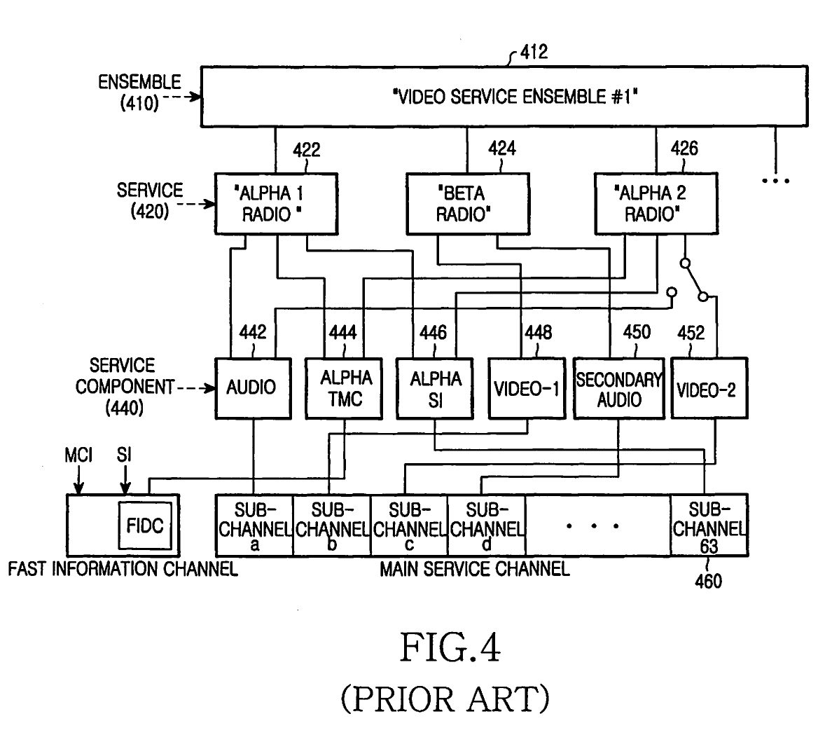

When 188-byte TS data is input from the RS decoder 522, the PID converter 510 identifies whether the input TS data corresponds to a video A, a video B, or a video C. In the present invention, a 13-bit PID is used to define a feature for each specific packet as in the case of FIG. 3.

The PID converter 510 converts a PID value of each of the corresponding sub-channels in an output value of the RS decoder 522. In order to convert the PID, a mask bit may be set to be used for PID conversion or an operation is selected to be used for PID conversion. Schemes for the operation may include Exclusive-OR, AND, OR, etc.

The present invention will be described taking an example of a case where a user selects two video channels.

A user enables two sub-channels to simultaneously receive two video broadcasting. It is assumed that two video broadcasting correspond to a sub-channel A and a sub-channel B, respectively.

The MPEG-2 TS data for each broadcasting has a Program Association Table (PAT). The PAT includes PID information of a Program Map Table (PMT). The PID information of the PMT includes PID information of each of the Elementary Streams (ESs) necessary to demultiplex the TS.

In order to view broadcasting, a PMT PID is extracted from a PAT of each of the channels, a video PID is extracted, an audio PID is extracted, etc. from the extracted PMT PID. Then, the TS demultiplexer monitors a PID, and the TS transmits a packet containing a video PID to a video decoder (not shown) and transmits a packet containing an audio PID to an audio decoder (not shown).

Moreover, PATs of all TS data have a value of 0x0 in the MPEG2-TS standard. Therefore, when two TS data are mixed and received, it is impossible to identify when a PAT of the received TS data corresponds to a sub-channel A or a sub-channel B. For this reason, the user sets both a mask bit and an operation to be used for masking on the RS decoder 520 for one sub-channel, to identify PATs between two sub-channels.

In the present invention, for a sub-channel A path, an exclusive-OR operation is set and a mask bit is set to have a value of 0x1fff (all of the 13 PID bits have a value of “1”). Then, a PAT for the sub-channel A is set to have a value of 0x1fff instead of a value of 0x0, and the packets are transmitted to a TS demultiplexer.

The TS demultiplexer detects both a packet containing the PID with a value of 0x0 and a packet containing the PID with a value of 0x1fff from among all received packets. According to the MPEG2-TS standard, the packet containing the PID with a value of 0x1ffff is defined as a null packet having no payload. Therefore, when the TS demultiplexer receives a packet containing the PID with a value of 0x1fff, the TS demultiplexer determines based on existence or absence of payload within the packet whether the received packet corresponds to a packet containing the PID of the PAT for the sub-channel A having a value converted by an exclusive-OR operation, or whether the received packet corresponds to a null packet of a sub-channel B. Similarly, when the TS demultiplexer receives a packet containing the PID having a value of 0x0, the TS demultiplexer determines based on existence or absence of payload within the packet whether the received packet corresponds to a packet containing the PID of a null packet for the sub-channel A having a value of 0x0 converted by an exclusive-OR operation, or whether the received packet corresponds to a PAT of the sub-channel B.

Then, the TS demultiplexer performs PAT parsing. It is possible to recognize all PIDs used for a current video service through the PAT parsing. When an identical PID is detected twice more, as a result of the PAT parsing, it is possible to recognize that the sub-channel A and the sub-channel B duplicately use the identical PID each other. In this case, the user sets both a mask bit and an operation to be used for masking on one RS decoder path of two sub-channels to distinguish the PIDs of two sub-channel from a PID of other sub-channel.

A method according to the present invention will now be described, in which, in order to avoid duplicated use of a PID, all PIDs detected from PTAs of two channels are performed according to a bit-OR operation, the result values and the value of 0x1fff (all of the 13 PID bits have a value of “1”) are performed according to an XOR operation, and a resultant value is used as a mask bit.

For example, if it is assumed that the PID of the sub-channel A has values of 0x0301, 0x0302, 0x0303, and 0x0304 and the PID of the sub-channel B has values of 0x0304, 0x0305, 0x0306, and 0x0307, the PIDs having a value of 0x0304 are duplicately used, so the reception side cannot identify that a corresponding PID belongs to the sub-channel A or the sub-channel B. In this case, the duplicated PID is used only once and all remaining PIDs are performed according to a bit-OR operation, to yield a result of 0x0301|0x0302|0x0303|0x0304|0x0305|0x0306|0x0307=0x0300, wherein ‘|’ represents a bit-OR operator.

The resultant value and a value of 0x1fff are performed according to an XOR operation, so a value of 0x1CFF is yielded.

If the mask bit for the sub-channel A is set to have a value of 0x1CFF, the PID of the sub-channel A and the mask bit are performed according to an XOR operation, and the PID is modified to have a value of 0x1FFE, 0x1FFD, 0x1FFC, and 0x1FFB, and the modified PID is transferred, whereas the PID of the sub-channel B is transferred without modification.

Therefore, the TS reception side can identify sub-channels based on the modified PID table.

Therefore, in a case where an output apparatus with one port simultaneously transmits a Single Program (SP) TS packet for multiple channels, a PID may be duplicately used depending on the setting of each TS packet. In this case, there is a method for adding a separate bit to a TS packet header so a TS reception side can identify a TS. However, imposed transmission overhead increases. According to the present invention, only an existing PID is modified to identify a TS, so an SP TS packet for multiple channels can be simultaneously transmitted by an output apparatus with one port without imposed transmission overhead.

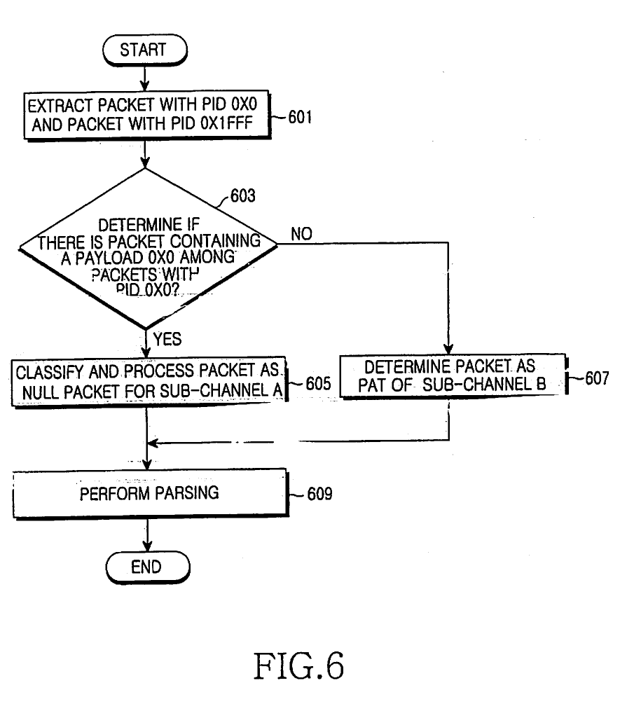

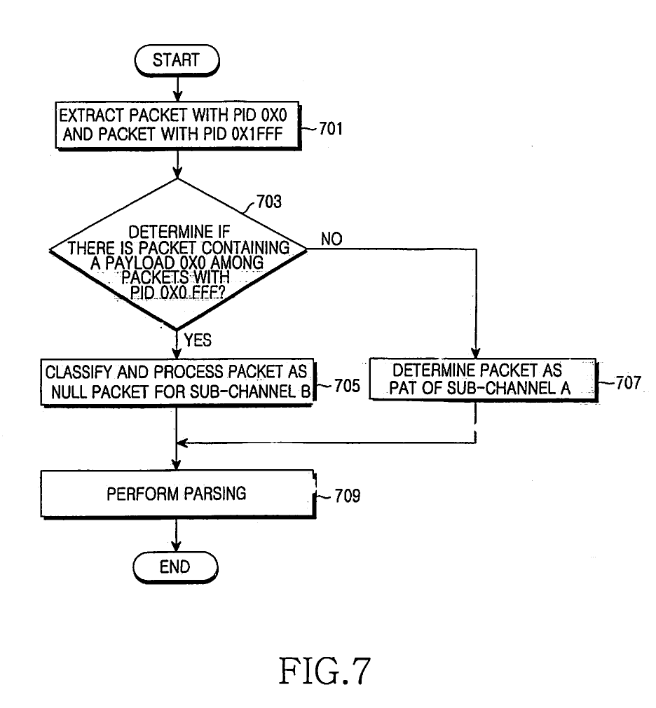

FIGS. 6 and 7 show processes where the TS reception side identifies a PAT of each sub-channel, and the TS reception side performs TS data according to the demultiplexing.

First, for the path of the sub-channel A, for example, an exclusive-OR operation is set and a mask bit is set to have a value of 0x1fff (all of the 13 PID bits have a value of “1”). Then, a PAT for the sub-channel A is set to have a value of 0x1fff instead of a value of 0x0, and the resultant packet is transmitted to a TS demultiplexer. A null packet of the sub-channel A is set to have a value of 0x0 instead of 0x1fff, and the resultant packet is transmitted to a TS demultiplexer.

In step 601, the TS demultiplexer extracts both a packet containing a PID with a value of 0x0 and a packet containing a PID with a value of 0x1fff from among all received packets.

In step 603, the TS demultiplexer determines whether there is a packet containing a packet payload with a value of 0x0 in the packets containing a PID with a value of 0x0.

When there is a packet containing a packet payload with a value of 0x0 in packets containing a PID with a value of 0x0, the TS demultiplexer classifies and processes the packet as a null packet of the sub-channel A in step 605, and the TS demultiplexer recognizes the packet having a payload as a PAT of the sub-channel B in step 607.

Similarly, as shown in FIG. 7, the TS demultiplexer extracts both a packet containing a PID with a value of 0x0 and a packet containing a PID with a value of 0x1fff from among all received packets in step 701.

In step 703, the TS demultiplexer determines whether there is a packet containing a packet payload with a value of 0x0 in packets containing a PID with a value of 0x1fff.

When there is a packet containing a packet payload with a value of 0x0 in packets containing a PID with a value of 0x1fff, the TS demultiplexer classifies and processes the packet as a null packet of the sub-channel B in step 705, and the TS demultiplexer recognizes the packet having a payload as a PAT of the sub-channel A in step 707.

Then, the TS demultiplexer performs PAT parsing in steps 609 and 709. It is possible to recognize all PIDs used for a current video service through the PAT parsing. If an identical PID is detected twice more, as a result of the PAT parsing, it is possible to recognize that the sub-channel A and the sub-channel B duplicately use the identical PID each other. In this case, the user sets both a mask bit and an operation to be used for masking on one RS decoder path of two sub-channels to distinguish the PIDs of two sub-channel from a PID of other sub-channel.

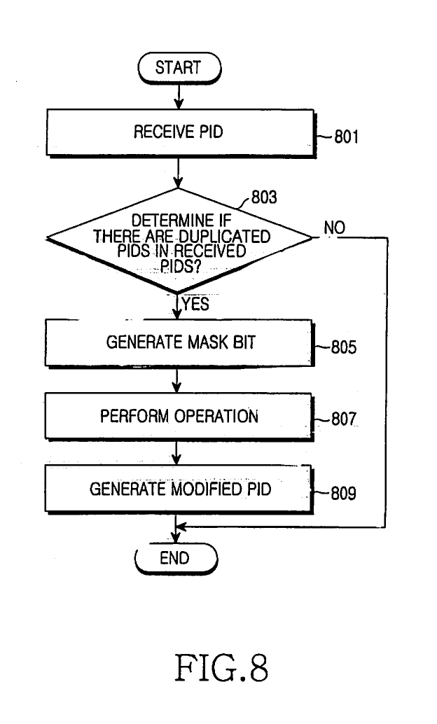

FIG. 8 shows a method for PID conversion, in which it is determined based on PAT information of each sub-channel obtained by FIGS. 6 and 7 when PIDs of respective ESs are duplicately used, and a PID conversion is performed when a PID is duplicately used.

Referring to FIG. 8, the PID converter 510 receives a PID within, for example, a 188-byte TS packet from the RS decoder 522 in step 801.

In step 803, the controller 514 determines whether there are duplicated PIDs in the received PIDs. When there are not duplicated PIDs in the received PIDs, the PID converter 510 terminates the process. However, when there are duplicated PIDs in the received PIDs, the PID converter 510 generates a mask bit in step 805. In this case, a bit-OR operation is performed with all PIDs, so that a mask bit is generated.

In step 807, the PID converter 510 performs operation by using the generated mask bit and the received PID. Schemes for the operation may include Exclusive-OR, AND, OR, etc.

In step 809, the PID converter 510 generates a modified PID, as a result of the operation.

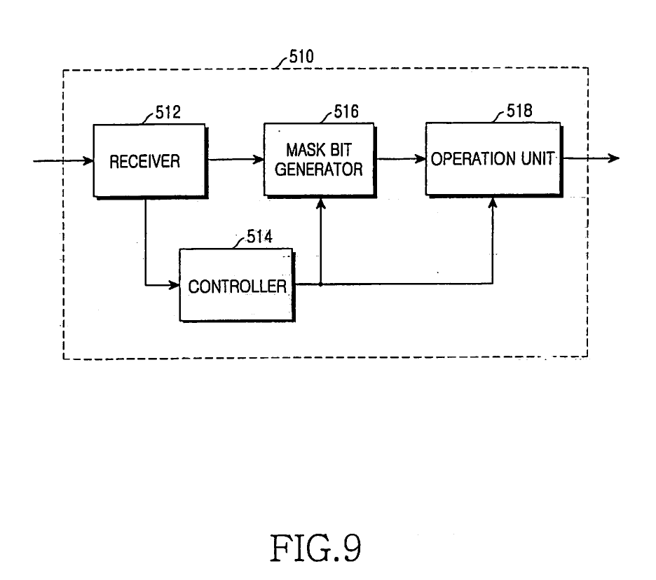

Meanwhile, FIG. 9 shows a PID converter according to the present invention.

The PID converter 510 includes a receiver 512, a controller 514, a mask bit generator 516, and an operation unit 518.

The receiver 512 receives a 188-byte TS packet from the RS decoder 522 and outputs the received packet to the controller 514 and the mask bit generator 516.

The controller 514 determines whether there are duplicated PIDs through the TS packet. When there are duplicated PIDs from the TS packet, the controller 514 controls the mask bit generator 516 to generate a mask bit.

Then, under the control of the controller 514, the mask bit generator 516 generates the mask bit to identify the duplicated PIDs, and outputs the generated mask bit to the operation unit 518.

Under the control of the controller 514, the operation unit 518 operates the generated mask bit and at least one of the duplicated PIDs, thereby outputting a converted PID. One of Exclusive-OR, AND, and OR operation schemes may be selected by the controller 514.

The operation unit 518 operates both the mask bit and at least one of the duplicated PIDs, thereby outputting the result to an Application Processor (AP) 540 through a Serial to Parallel interface (SPI) 530.

Then, the AP 540 can identify PIDs corresponding to each service.

Now, representative effects resulting from the disclosed present invention as described above will be briefly described.

In the present invention, when at least two video services are provided using identical PIDs within one ensemble of a VHF digital radio broadcasting receiver, a reception side can identify a PID corresponding to each service to achieve a normal video service.

In the present invention, only an existing PID is modified to identify a TS, so a reception side can identify a PID corresponding to each service without imposed transmission overhead.

While the invention has been shown and described with reference to a certain preferred embodiments thereof, it will be understood by those skilled in the art that various changes in form and details may be made therein without departing from the spirit and scope of the invention as defined by the appended claims.

What is claimed is:

1. An apparatus for Packet Identifier (PID) conversion in a digital radio broadcasting receiver, the apparatus comprising:
a receiver for receiving PIDs within Transport Stream (TS) packets;
a mask bit generator for generating a mask bit when there are duplicated PIDs in the received PIDs; and
an operation unit for operating the generated mask bit and at least one of the duplicated PIDs, and outputting a converted PID.

2. The apparatus as claimed in claim 1, further comprising a controller for determining whether there are duplicated PIDs in the received PIDs.

3. The apparatus as claimed in claim 1, wherein the operation unit selectively uses one of Exclusive-OR, AND, and OR operation schemes.

4. A method for Packet Identifier (PID) conversion in a digital radio broadcasting receiver, the method comprising the steps of:
receiving PIDs within Transport Stream (TS) packets;
generating a mask bit if there are duplicated PIDs in the received PIDs; and
operating the generated mask bit and at least one of the duplicated PIDs, and outputting the converted PID.

5. The method as claimed in claim 4, further comprising determining if there are duplicated PIDs in the received PIDs.

6. The method as claimed in claim 4, wherein, in the operating step, one of Exclusive-OR, AND, and OR operation schemes is selectively used.

7. A digital radio broadcasting receiver comprising:
a demultiplexer for demultiplexing Transport Stream (TS) packets received through a wireless network and outputting the demultiplexed packets;
a decoder for decoding the demultiplexed TS packets; and
a Packet Identifier (PID) converter for generating a mask bit when there are duplicated PIDs in PIDs of the decoded TS packets, operating the generated mask bit and one of the duplicated PIDs, and outputting a converted PID.

8. The digital radio broadcasting receiver as claimed in claim 7, wherein the PID converter determines whether there are duplicated PIDs in the received PIDs.

9. The digital radio broadcasting receiver as claimed in claim 7, wherein the PID converter selectively uses one of Exclusive-OR, AND, and OR operation schemes.
